(19) United States
(12) Patent Application Publication
(10) Pub. No.: US 2012/0281756 A1
(43) Pub. Date: Nov. 8, 2012

(54) Complexity change detection for video transmission system

(76) Inventors: Francisco J. Roncero Izquierdo, Leganes (ES); Alberto Duenas, Mountain View, CA (US)

(21) Appl. No.: 13/067,048

(22) Filed: May 4, 2011

(51) Int. Cl. H04N 7/26

(52) U.S. Cl. 375/240.13; 375/E07.243

(57) ABSTRACT

A video transmission system includes an encoder and a decoder. As video data is encoded, the system uses temporal or spatial prediction to reduce the number of bits needed to encode frames. An increase in the complexity of the data results when motion vectors or patterns occurs. The complexity change is detected for intra-frame and inter-frame frames by monitoring statistics and motion estimation information for the macroblocks within the current frame. Once the complexity change is detected, the encoder or the system takes actions to prevent latency, bit rate fluctuation or quality degradation for the video transmission.

### FIELD OF THE INVENTION

The present invention relates to transferring video signals over a network. More particularly, the present invention relates to detecting a complexity change within the video signal transmission to minimize possible quality degradation or latency issues due to the system constraints.

### DISCUSSION OF THE RELATED ART

Before transmitting video content over a network, a video frame is compressed using an algorithm to encode the data. Some of these algorithms may be complex and the amount of data significant. For a defined video compression system, the necessary bit rate to achieve a specific video quality may depend on the complexity of the image being encoded. Complex images may require a higher bit rate for encoding.

To reduce the amount of data to encode, known video transmission systems may use prediction processes to re-use parts of an image already available. Known systems may use temporal prediction or spatial prediction to reduce the data rate needed to transmit video signals. Intra-frame prediction may be spatial while inter-frame prediction may use both temporal and spatial methods.

Further, rate control of the encoding process for the video transmission system may constrain changes in the complexity of the incoming video. Statistics from the previous frame having a same type of the current frame are used by the rate control to set the appropriate compression ratio for the current frame. As well as a target constant bit rate and a latency requirements, a rate control objective is to try to keep quality as stable as possible at both levels frame by frame and within the frame. The complexity of the previously encoded frame may be used to control the compression ratio for the current frame while using the previously allocated bits with a goal of remaining within the bit rate and latency constraints. This process also avoids having to use information from a future frame to encode the current frame, which may introduce additional latency.

Video compression methods for transmission use inter-frame prediction to reduce the amount of information required for transferring video data from the encoder to the decoder within the system. Any prediction technique takes into account motion estimation. Objects and persons within the video move, and such movement may cause an increase in the complexity of data as motion estimation data is captured.

For motion estimation prediction, consecutive video frames will be similar except for changes induced by objects moving within the frames. In cases of little to no motion between frames, the encoder may efficiently predict the current frame as a duplicate of the prediction frame. When this is done, the information transmitted to the decoder is the data necessary to reconstruct the picture from the original reference frame.

When there is motion in the images, the data used to reconstruct the image with the motion is more complex as motion vectors may be assigned to an encoded macroblock. Motion vectors may indicate how far a predicted macroblock is moved horizontally and vertically within the image frame. A large number of macroblocks having motion vectors strains the encoding process as more data is attached to the encoded macroblock. Such an event may be termed a complexity change.

Complexity changes are important to rate control operation because an unexpected change in the current frame complexity in relation to the previous frame may break the estimation process that predicts compression level. A complexity change may result in a noticeable decrease in quality of the video. To compensate, known video systems may buffer the data before transmission. For complex data, a greater amount of data is buffered, thereby introducing latency into the video transmission system.

Latency also may cause problems with current video transmission systems for those systems desiring real-time playback or interactive applications. A low end-to-end latency is maintained. For example, video surveillance systems and the like cannot afford delays in receiving video images. A video gaming system may require little to no latency in displaying images received from the console. Thus, any technique imposing extra processing time may be unfeasible in the encoding process.

### SUMMARY OF THE INVENTION

Embodiments of the present invention disclose a complexity change detection process for a video transmission system that detects and minimizes the quality degradation due to the presence of complexity changes in predicting video images while not severely impacting the rate control for the system. The system detects and minimizes the degradation or possible latency and bit rate impacts by using different processes for the type of frames being transmitted in the system.

For inter-frame predicted frames of the video transmission, the disclosed embodiments may use the motion estimation information derived from the changes in the macroblocks and the compression level for the current frame. These parameters are compared with the previously used parameters used on inter-frame coded frames to detect the complexity change.

For intra-frame predicted frames, the disclosed embodiments compare the compression level used on the current frame with the previous intra-frame predicted frame. If the compression level deviates from the previous level, then a complexity change may have occurred. Intra-frame prediction relies on information within the current frame, and not on previously coded frames.

Upon complexity change detection, the disclosed embodiments may reallocate bits and perform special compression ratio management to minimize the impact of the complexity change on video quality in the encoded video. The disclosed embodiments may do so where the buffer status allows it. The disclosed embodiments also may dynamically update all corresponding statistics for achieving the objective of acceptable quality and low latency, such as motion estimation information from the encoding process and the compression level used from the rate control.

According to the preferred embodiments, a method for encoding macroblocks within an image frame of a video transmission system. The method includes determining whether the image frame is an intra-frame image frame or an inter-frame image frame. The method also includes detecting the complexity change for the inter-frame image frame if motion pattern data for a set of macroblocks exceeds a motion threshold. The method updates the motion threshold during coding process to track complexity changes of the video sequence being encoded. The method also includes detecting the complexity change for the intra-frame image frame if an average compression level of the set of macroblocks exceeds a compression level threshold. The method also includes setting new encoding parameters for the image frame.

Further according to the preferred embodiments, a method for detecting a complexity change within an image frame of a video transmission system. The method includes determining a number of motion vectors for a set of macroblocks within the image frame. The method also includes determining whether motion pattern data for the number of motion vectors exceed a motion threshold. The motion pattern data corresponds to movement of the set of macroblocks. The method also includes indicating a complexity change within the image frame if the motion threshold is exceeded.

Further according to the preferred embodiments, a method for encoding an image frame within a video transmission system is disclosed. The image frame includes a complexity change based on motion of a set of macroblocks within the image frame. The method includes determining motion pattern data of the motion of the set of macroblocks. The method also includes detecting the complexity change within the image frame based on the motion pattern data. The method also includes setting new encoding parameters for the image frame according to the complexity change.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a video transmission system for transmitting and receiving video signal data according to the disclosed embodiments.

FIG. 2 illustrates image frames of a video transmission according to the disclosed embodiments.

FIG. 3 illustrates a flowchart for detecting a complexity change within the video transmission system according to the disclosed embodiments.

FIG. 4 illustrates a flowchart for managing a buffer within the video transmission system during the complexity change according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

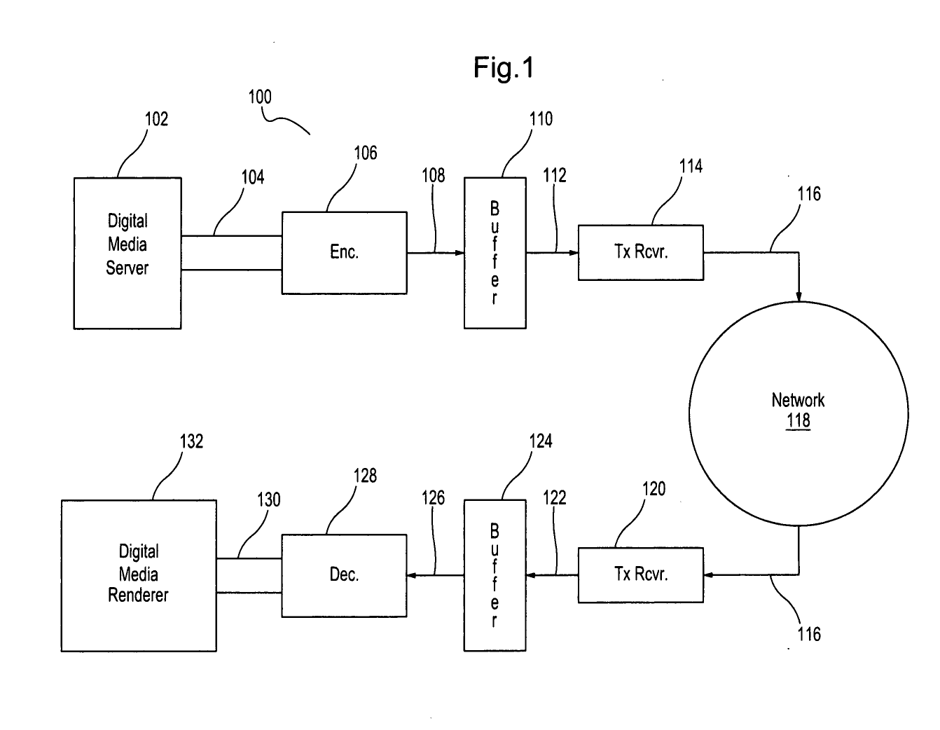

FIG. 1 depicts a system 100 for transmitting and receiving video signal data according to the disclosed embodiments. System 100 may be any system or collection of devices that connect over a network to share information. System 100, for example, may be a gaming system where video content is generated in the gaming console and then transmitted to a high-definition digital media renderer, such as a flat-screen television. Alternatively, system 100 may be a security monitoring system using high definition (HD) video.

Digital media server 102 generates the video content to be transmitted. Digital media server 102 may be any device, console, camera and the like that captures video data. The content generated from digital media server 102 is displayed for a user to view and interact with in real-time. Digital media server 102 may be a computer, video recorder, digital camera, gaming console, scanner and the like that captures data.

Uncompressed data signal 104 is output from digital media server 102 to encoder 106. Encoder 106 may encode or compress signal 104 for transmission within system 100. Encoder 106 may use lossy compression techniques to encode signal 104. The strength of such techniques (compression level) may change based on the complexity of the data within signal 104. For example, video data of a character in a game swinging a sword against an opponent is more complex, or very busy, than video of the character merely standing and could require different encoding processes to keep similar quality. The action of swinging a sword results in the creation of motion vectors within the image frame.

The video data is comprised of images that are encoded for transmission. The images include pixels that can be encoded to represent information within the pixel, such as color, luminance and motion. This information is transmitted and reconstructed. As noted above, a scene change within the images results in a change in this information as a pixel from one frame will be different in the subsequent frame.

Rate control is part of the encoding process that addresses any change in complexity of the incoming video from uncompressed data signal 104. Rate control also maintains the parameters for system 100 that meets the requirements from a constant bit rate transmission channel or a low end-to-end latency system. The complexity of the previously encoded frame may be used to control the compression ratio for the current frame. This action avoids the use of information from future frames to encode the current frame, thus reducing the possibility of additional latency. The previously allocated bits also may be used to achieve the bit rate and latency desired within system 100.

Encoder 106 outputs compressed signal 108 to buffer 110. Buffer 110 stores data from signal 108 until it can be transmitted through system 100. If the network bit rate does not allow transmission of signal 108, then buffer 110 holds the data until such time it can be transmitted by transceiver 114. System 100 seeks to limit any storing of data within buffer 110 so that little to no latency occurs. Buffer 110 outputs signal 112 to transceiver 114.

Transceiver 114 transmits signal 116 over network 118. Using the gaming example from above, network 118 may be a wireless network for a location where a router receives signal 116 from digital media server 102 and forwards it to digital media renderer 132 for display. Alternatively, network 118 may be a network of computers receiving signal 116 from a remote camera showing real-time video.

Transceiver 120 receives signal 116 and outputs signal 122 to buffer 124. Signal 126 streams from buffer 110 to decoder 128. Decoder 128 decodes or decompresses signal 126 to generate uncompressed signal 130. The information representing the pixels of the current image is used to reconstruct the image. Some information, however, may be lost during this process. Decoded signal 130 preferably is a high quality copy of uncompressed signal 104, which slight variations due to the coding process.

Digital media renderer 132 receives decoded signal 130 and displays the video data content to the user. Digital media renderer 132 may be a high-definition television having display resolutions of 1,280×720 pixels (720p) or 1,920×1,080 pixels (1080i/1080p). Thus, the amount of data encoded and decoded within system 100 may be complex due to the demands place on it by digital media server 102 and digital media renderer 132.

System 100 is subject to various constraints and parameters. System 100 may transmit over network 118 at a constant bit rate. This bit rate may remain about the same over time, but, however, may change under certain circumstances. A delay or integration time may occur as buffer 110 fills up, which causes latency within system 100.

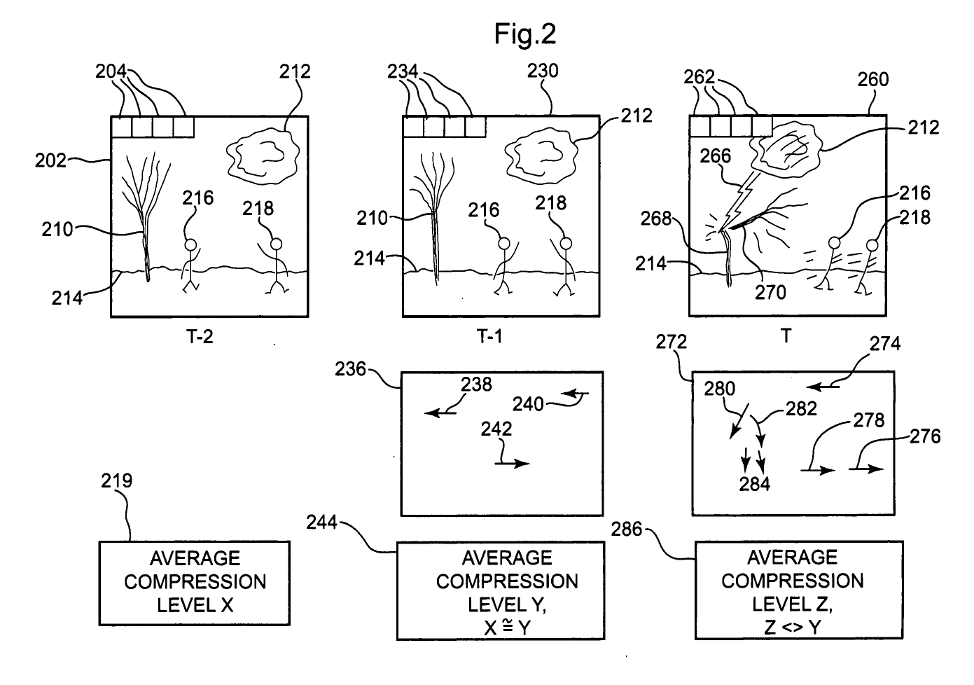

FIG. 2 depicts image frames 202, 230 and 260 of a video transmission according to the disclosed embodiments. In the sequence of images shown, frame 260 represents a complexity change due to increased motion vectors at time T. Frame 202 occurs at time T−2, or two frames prior to frame 260. Frame 202 also may be referred to as a reference frame for follow-on frames 230 and 260. If video transmission system 100 transmits 60 frames per second, then T−2 may represent the frame 2/60ths of a second before T. Frame 230 occurs at time T−1. Additional frames may occur prior to time T.

Frame 202 includes macroblocks 204. A macroblock may be a collection of pixels in an array, such as 8×8 or 16×16, that represents a location within frame 202. Encoder 106 encodes or compresses macroblocks 204 into digital information for transmission. Macroblocks are not necessarily identical but groups of macroblocks may be similar in information.

For example, frame 202 may include tree 210, cloud 212, person 216 and person 218. Frame 202 also may have a horizon 214 in the background. Macroblocks representing the image of person 216 differ from those for cloud 212. When encoded, macroblocks 204 include information regarding luminance and chrominance information, such as red, blue or other primary color difference information. Thus, significant changes in this information for the macroblocks from one frame to the next results in a corresponding increase in encoded information for the macroblocks.

Frame 230 is similar to frame 202 in that the items in the frames do not move significantly. Thus, encoder 106 may predict the information for macroblocks 234 of frame 230 by using information for macroblocks 204. Horizon 214 also stays steady in frame 220. The only differences may be the slight changes in position of cloud 212 and person 216. The disclosed embodiments may use inter-frame prediction for a majority of macroblocks 234 within frame 230 in that the predicted values for macroblocks 222 rely on a previous frame, but also use spatial prediction for those macroblocks 234 representing person 216 and cloud 212. Spatial prediction may use macroblocks 234 within frame 230 as opposed to previous macroblocks 204 within frame 202.

As the predicted macroblocks are identified, the encoding process notes that they have moved relative to the previous frame 202. Thus, these macroblocks will include motion estimation information along with the encoded macroblock information. In other words, upon decoding the macroblock information, decoder 128 is told to move the previously encoded macroblock to another position within frame 230. Although other information may stay the same, the motion estimation is included with the encoded frame. Large amount of motion estimation information due to lots of movement within the frame may result in buffering an increasing amount of data and latency issues.

Referring back to frame 230, motion vector block 236 shows motion vectors that represent the movement of features as compared to previous frame 202. Essentially, the encoding process performs predictive algorithms and determines that the macroblocks for cloud 212, the branches for tree 210 and person 216 have moved within frame 230. Though much of their other information, such as chrominance and luminance, may stay the same between frames, their location does not. Thus, motion vector 238 represents the movement of branches on tree 210 very slightly due to wind, while motion vector 240 represents the gradual movement of cloud 212. Motion vector 242 represents the movement of person 216 towards person 218. The total motion estimation information needed to reconstruct these motion vectors should not cause bit rate or latency problems within system 100. A complexity change does not need to be alerted between frames 202 and 230.

Frame 260, however, may differ significantly from previous frames 202 and 230. A lot of movement is noted within the frame. Frame 260 includes macroblocks 262. A few macroblocks 262 may be predicted from the information in the previous frames, but a large percentage will need to be encoded. Thus, the workload placed on system 100 will increase to meet the complexity of the information due to the scene change.

Frame 260 includes features from frame 230, yet these features, and their corresponding macroblocks 262, move significantly from the previous frame. All this movement, or motion, results in additional motion estimation information being encoded and sent within system 100. For example, cloud 212 moves and becomes dark. Lightning bolt 266 may emit from cloud 212 towards what used to be tree 210. Tree 210 is broken in two parts, 268 and 270. Persons 216 and 218 run from the lightning strike to safety.

As a result, macroblocks 262 may use previously predicted information to predict the chrominance and luminance, but their locations within frame 260 changes dramatically. Motion vector block 272 shows the motion vectors generated by the movements. The motion vectors produce motion estimation information, as disclosed above.

Motion vector 274 represents the movement of cloud 212, and should be larger than motion vector 240 of motion vector block 236. Motion vector 280 may represent lightning 266, or the movement of macroblock 262 showing the air or sky in that location of frame 260. Motion vector 282 represents top part 270 of tree 210 falling towards horizon 214. Motion vectors 284 may represent the branches also falling towards horizon 214. Motion vectors 276 and 278 represent the movement of persons 218 and 216, respectively, within frame 260. Some of the motion vectors 274-284 also may be long, and thus resulting in additional motion estimation information.

The number of motion vectors along with their size results in a complexity change from frame 230 to frame 260. “A complexity change” indicates that an unexpected change of the motion pattern occurred that could cause unexpected consumption of bits or quality variation. Detection of the complexity change minimizes the impact of both situations on system 100.

Referring back to frames 202 and 230, the complexity of encoded frame 202 may be used to control the compression ratio for frame 230. The rate control also may use the previously allocated bits for frame 202 with the goal of achieving a bit rate and latency desired in system 100. Encoder 106 does not have to re-establish these values. Except for minor variations shown by the motion vectors within motion vector block 236, the predicted macroblocks 234 for frame 230 should be able to use the previously encoded information for macroblocks 204.

Frame 260, however, departs from this process and the complexity of frame 230 does not apply. Frame 260 possibly needs a higher compression ratio and an increased number of allocated bits to accommodate the unexpected change in the motion patterns as well as their longer length. The complexity change may be detected, and the rate control of system 100 may adjust accordingly.

As disclosed above, intra-frame prediction does not rely on previously encoded frames to predict macroblocks. Thus, motion vector information may not be available or applicable for complexity change detection. For intra-frame prediction, blocks 219, 244 and 286 may represent parameters or statistics pertaining to the respective frames 202, 230 and 260. All macroblocks within an intra-frame image frame are intra-macroblocks in that they do not depend on previous macroblock information in predicting its values.

Statistic 219 indicates that the average compression level for macroblocks 204 is “X.” X may represent a number corresponding to a standard level for compression, such a number between 0 and 12. A compression level of 0 may indicate no compression is performed, such as when frame 202 and 220 are completely identical. A compression level of 1 may indicate minimum encoding was done, and due to the predicted macroblocks, the bit rate needed to transmit the information is acceptable. A compression level of 12, however, may indicate a complex compression where the bits needed for compression increases significantly, such as when the macroblocks differ greatly from each other within the image. Other numbers and designations may be used for compression levels.

The average compression level X, therefore, represents an average number for all the compression level numbers of macroblocks 204 of frame 202. Statistic 244 represents the average compression level Y for macroblocks 234 of frame 230. Because frame 202 and 230 are similar, average compression level Y is approximately equal to average compression level X. The disclosed embodiments may set an acceptable variance between statistics 219 and 244 to show that a complexity change does not occur, such plus or minus 10%.

Statistic 286 represents the average compression level Z for macroblocks 262 of frame 260. Because of the increased amount of motion within frame 260, the average compression level Z should be greater than average compression level X or Y. Macroblocks 262 require more information for encoding. Frame 260 may represent a lot of action or motion that prevents spatial prediction of macroblocks 262 in any meaningful manner.

Thus, the disclosed embodiments may examine a set of macroblocks 262 as frame 260 arrives at encoder 106 to see if the average compression levels differ, and a complexity change is imminent. The unexpected increase of the average compression level for the scene change within frame 240 may cause unexpected consumption of bits or significant quality variation. A timely detection of a complexity change may minimize the impact to both of these.

Thus, due to the increased complexity from motion within frame 260, various statistics will indicate such a change. Using these statistics for a frame during encoding allows the disclosed embodiments to detect a complexity change. After detection, the rate control, bit rate, buffer allocation and the like may be adjusted to provide a quality video transmission without significant end-to-end latency.

Depending on whether the prediction for a current frame is inter-frame or intra-frame, the disclosed embodiments may utilize the aspects of the frames disclosed above to detect a complexity change. Inter-frame predicted frames may use the motion estimation information for increased number or length of motion vectors as well as the average compression level to detect a complexity change within the frame. An intra-frame predicted frame may use the difference in complexity, or compression, levels to detect the change. Thus, the disclosed embodiments detect complexity changes no matter which type of frame is used. This process is disclosed in greater detail below.

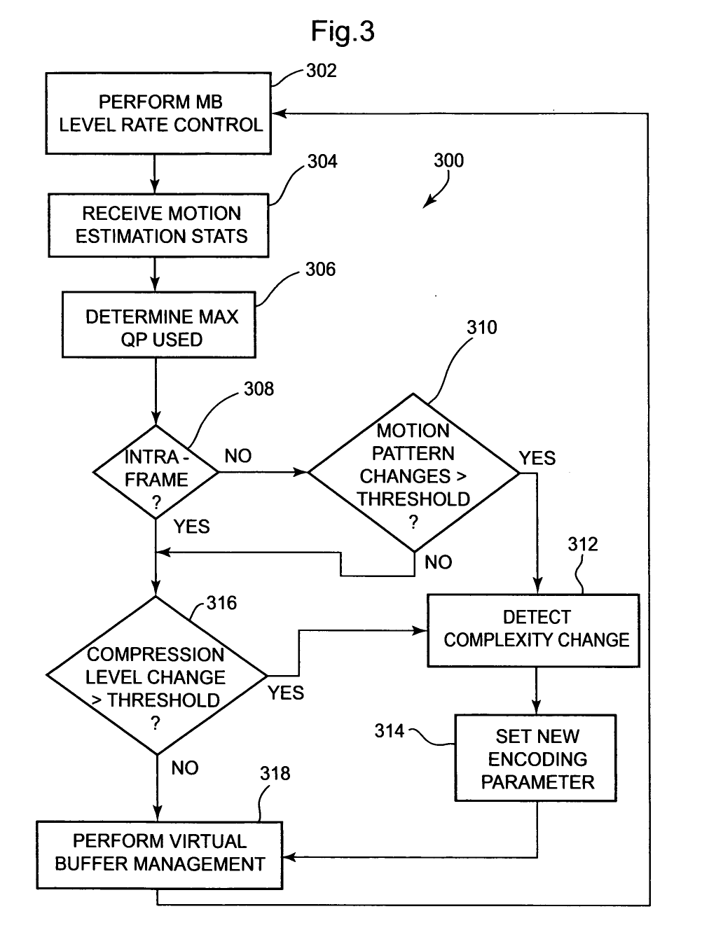

FIG. 3 depicts a flowchart 300 for detecting a complexity change within video transmission system 100 according to the disclosed embodiments. Step 302 executes by performing macroblock level rate control for the current frame. Based on the rate control for the previous frame, system 100 may set various parameters such as bit rate, bit allocation and buffer size to the previous frame. Step 304 executes by receiving motion estimation statistics from the previous frame. For example, referring to frames 230 and 260, the motion estimation information for the motion vectors within the previous frame is provided. Further, additional information may be provided such as intra-macroblock statistics, for example, statistic 244, for the average compression level for macroblocks within the previous image frame. Step 306 executes by determining the maximum compression level used for encoding the macroblocks.

Step 308 executes by determining whether the current frame, such as frame 260, is an intra-frame. If step 308 is no, then the current frame is an inter-frame that may be predicted using temporal prediction. For an inter-frame, both the motion patterns or vectors and compression level may be checked to detect a complexity change. Thus, step 310 executes by determining whether the motion pattern or vector changes for the current frame exceed a threshold set by system 100. This threshold may be, known as a motion threshold. In other words, step 310 determines whether the motion estimation information needed to encode the increased or longer motion vectors will exceed a threshold able to handle the changes without declaring a complexity change. For example, this threshold may be 40% of macroblocks have moved substantially within the current frame. If step 310 is yes, then step 312 is executed. Step 312 is disclosed in greater detail below. If step 310 is no, then step 316 is executed, also disclosed in greater detail below.

If step 308 is yes, then the current frame is an intra-frame. An intra-frame indicates that macroblock prediction is done by spatial prediction, and not temporal prediction. Moreover, if step 310 is no, then flowchart 300 goes to step 316. Step 316 executes by determining whether the compression level exceeds a threshold. This threshold may be known as a compression level threshold, and relates to the normal compression level for an intra-frame image frame. As shown by compression level statistics in FIG. 2, the average compression level should remain steady between frames that do not include a complexity change. An increase in the average compression level indicates a possible complexity change, such as in frame 260.

Thus, step 316 determines whether the compression level for macroblocks within the current frame is above a threshold for the average compression level. This threshold may be set by system 100. For example, if compression levels are between 1 and 12, then an average compression level above 7 may indicate a complexity change due to increased motion within the frame.

If step 316 is yes, then step 312 executes by detecting a complexity change within the current frame. Further, step 312 may incorporate new rate control parameters to accommodate the complexity change, such as adjusting bit allocation or other remedial measures. Encoder 106 is alerted of the complexity change, and may adjust buffer 110 accordingly. Preferably, buffer 110 is kept small, such as about the size of a frame, to prevent latency within system 100.

Step 314 executes by setting, or implementing, a new encoding parameter or set of parameters for the current frame to allow for the increased complexity within the frame. In short, the parameters received to encode the current frame are overridden by the new set of parameters to encode the complexity change.

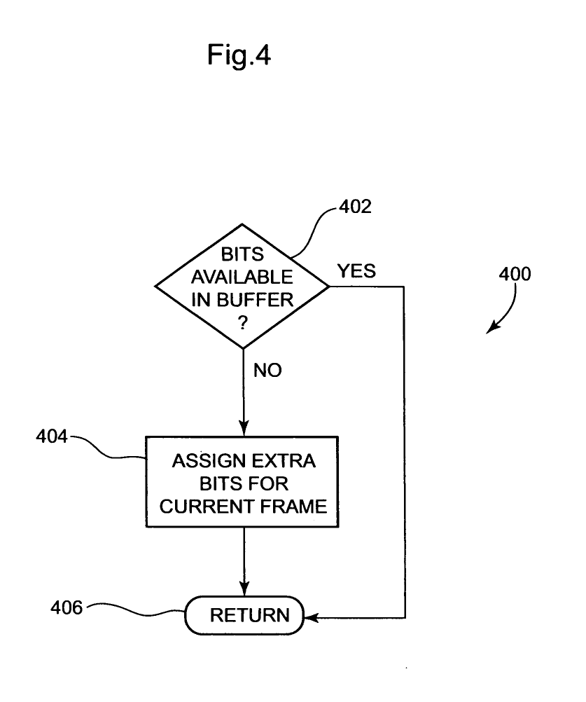

Step 318 executes by performing virtual buffer management. This step is disclosed in greater detail by FIG. 4. Virtual buffer management allows buffer 110 to handle the increased complexity of the encoded data caused by the scene change. Upon completion of step 318, flowchart 300 returns to step 302 for a new frame.

Thus, the disclosed embodiments enable complexity change detection at the macroblock level. Further, the disclosed embodiments are not limited to one prediction scheme, but can operate with temporal and spatial prediction schemes. The disclosed embodiments also may work with intra-macroblocks as well as inter-macroblocks. The statistics for these macroblocks are gathered and compared to identify a complexity change so that encoder 106 may take action to accommodate any bit rate fluctuations or prevent latency from creeping into system 100.

FIG. 4 depicts a flowchart 400 for managing a buffer within video transmission system 100 according to the disclosed embodiments. Flowchart 400 may relate back to step 318 of FIG. 3, and is executed primarily when a complexity change is detected. Step 318, however, may be executed when a complexity change is not detected to allow the disclosed embodiments the ability to manage the buffer status.

Step 402 executes by determining whether enough bits are available in the buffer, such as buffer 110, to encode the current frame. The increase in complexity of the data due to higher motion patterns or vectors may result in a bit rate fluctuation that fills or possibly spills over buffer 110. Because the current frame cannot reliably depend on temporal or spatial prediction to reduce data complexity, the new data generated by the scene change is encoded or compressed using the algorithms to capture all the data for the macroblocks within the frame, including motion estimation information resulting from the motion vectors and patterns.

If step 402 is yes, then enough bits are available, and flowchart 400 goes to step 406. Step 406 returns back to the previous flowchart for further operations. If step 402 is no, then step 404 executes by assigning extra bits for the current frame so that the increased data complexity is handled. Step 404 may assign bits reserved for a subsequent frame or may increase the size of the virtual buffer to accommodate the bits. For example, encoder 106 may assign 10% more bits for encoding the current frame to prevent latency within system 100 and degradation in video quality. Step 406 then returns back to the previous flowchart for further operations.

It will be apparent to those skilled in the art that various modifications and variations may be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A method for encoding macroblocks within an image frame of a video transmission system, the method comprising:
determining whether the image frame is an intra-frame image frame or an inter-frame image frame;
detecting the complexity change for the inter-frame image frame if motion pattern data for a set of macroblocks exceeds a motion threshold;
detecting the complexity change for the intra-frame image frame if an average compression level of the set of macroblocks exceeds a compression level threshold; and
setting new encoding parameters for the image frame.

2. The method of claim 1, wherein the motion pattern data includes motion vectors within the image frame for the set of macroblocks.

3. The method of claim 1, further comprising also detecting the complexity change for the inter-frame image frame if the average compression level of the set of macroblocks exceeds the compression level threshold.

4. The method of claim 1, further comprising performing virtual buffer management for the video transmission system based on the complexity change.

5. The method of claim 1, wherein the compression level threshold corresponds to a normal compression level for a previous image frame.

6. The method of claim 1, further comprising determining a maximum quantization parameter for the set of macroblocks.

7. The method of claim 1, wherein the setting step includes modifying a rate control parameter for the video transmission system.

8. The method of claim 1, further comprising determining whether enough bits are available in a buffer for the new encoding parameters.

9. The method of claim 8, further comprising assigning a number of extra bits to encode the image frame if the buffer does not have enough bits.

10. A method for detecting a complexity change within an image frame of a video transmission system, the method comprising:
determining a number of motion vectors for a set of macroblocks within the image frame;
determining whether motion pattern data for the number of motion vectors exceed a motion threshold, wherein the motion pattern data corresponds to movement of the set of macroblocks; and
indicating a complexity change within the image frame if the motion vector threshold is exceeded.

11. The method of claim 10, further comprising determining an average compression level for the set of macroblocks.

12. The method of claim 11, further comprising indicating the complexity change if the average compression level exceeds a compression level threshold for the image frame.

13. The method of claim 10, further comprising setting new encoding parameters for the image frame, wherein the new encoding parameters are based upon the complexity change.

14. The method of claim 10, further comprising overriding a previous set of parameters with the new encoding parameters.

15. The method of claim 10, further comprising assigning a number of bits to encoding the image frame if a buffer condition allows.

16. A method for encoding an image frame within a video transmission system, wherein the image frame includes a complexity change based on motion of a set of macroblocks within the image frame, the method comprising:
determining motion pattern data of the motion of the set of macroblocks;
detecting the complexity change within the image frame based on the motion pattern data; and
setting new encoding parameters for the image frame according to the complexity change.

17. The method of claim 16, further comprising detecting the complexity change if an average compression level of the set of macroblocks exceeds a compression level threshold.

18. The method of claim 16, wherein the image frame includes an inter-frame image frame.

19. The method of claim 16, wherein the setting step includes modifying a bit rate for the video transmission system.

20. The method of claim 16, further comprising assigning an extra number of bits to initial bits allocated for the image frame if a buffer condition allows.

21. The method of claim 1, wherein the motion threshold is updated during a coding process to set a motion pattern reference for complexity change detection.
